(19) United States
(12) Patent Application Publication
(10) Pub. No.: US 2007/0043950 A1
(43) Pub. Date: Feb. 22, 2007

(54) TARGET APPARATUS, CERTIFICATION DEVICE, AND CERTIFICATION METHOD

(75) Inventors: Masayuki Imanishi, Kanagawa (JP); Koichi Ogasawara, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/462,808

(22) Filed: Aug. 7, 2006

(30) Foreign Application Priority Data
Aug. 16, 2005 (JP) 2005-235613
Aug. 16, 2005 (JP) 2005-235611
Aug. 16, 2005 (JP) 2005-235612

(51) Int. Cl. H04L 9/00

(52) U.S. Cl. 713/176; 380/270

(57) ABSTRACT

The present invention has a target apparatus that provides a predetermined service by certifying a certification device when said certification device enters a predetermined certification area. The target apparatus includes a controller configured to control the changing of contents of a service to be provided in accordance with a certification status of a plurality of certification devices located inside said certification area.

### CROSS REFERENCES TO RELATED APPLICATIONS

The present invention contains subject matter related to Japanese Patent Application JP 2005-235613 filed in the Japanese Patent Office on Aug. 16, 2005, Japanese Patent Application JP 2005-235611 filed in the Japanese Patent Office on Aug. 16, 2005, and Japanese Patent Application JP 2005-235612 filed in the Japanese Patent Office on Aug. 16, 2005, the entire contents of which being incorporated herein by reference.

### BACKGROUND OF THE INVENTION

1. Field of the Invention

The present invention relates to a target apparatus for executing usage restriction on the basis of certification, a certification device for executing certification processing by taking user certification information and positional information into account, and a certification method for providing predetermined services on the basis of the certification by the target apparatus.

2. Description of the Related Art

In related-art technologies, if a certification device for personal identification (the UIM (User Identity Module) for example) is used as a connection device for the connection to a particular site, the user can access such a site from any terminal regardless of locations; if the certification device is used mainly in a remote log-in operation, the user can browse confidential corporate data, mail, and so on even when the user is in an urban area.

To be more specific, normally, when the user accesses confidential data such as personal information inside the office, the user uses a particular terminal in a particular office room. However, the use of the above-mentioned certification device allows the user to access the data from any terminal arranged in a restricted area in which the access is permitted. Japanese Patent No. 2931276 (referred to as Patent Document 1 hereinafter) and Japanese Patent No. 3498633 below disclose certification technologies based on wireless lines.

Generally, the personal certification for the user to operate a terminal is executed by means of user name and password. Recently, a certification method based on the wireless UIM technology has come to be applied, in which certification is automatically executed when a wireless UIM gets close to a terminal device, thereby simplifying personal certification.

For technologies associated with equipment usage restricting devices, one is disclosed in Patent Document 1 below in which, when an identification signal transmission unit gets away from a usage-restriction clearing unit by a predetermined distance, a usage restriction signal outputted from the usage-restriction clearing unit is stopped, thereby making a target device unusable.

### SUMMARY OF THE INVENTION

However, in the case of one to one certification of terminal device and wireless UIM, the following problems can be raised. Namely, when confidential information for example is being handled on a terminal device such as a personal computer by an authorized operator, the confidential information may be exposed to prying eyes standing behind the operator, for example, thereby causing information leakage. It is difficult for related-art technologies to prevent information from being leaked to prying eyes.

In the case of setting important devices such as servers installed for banking business, for example, a configuration is often used that two or more persons have to be present at the time of executing setting operations for security. In this case, the participation of two or more persons in the setting operations may be verified by the certification based on the user name and the password of each person that are loaded on the terminal device on which the setting operations are being executed or based on a smart card held by one person and the password loaded by another.

However, the method in which the password is used may impose a risk of permitting a third party to change server settings if the person who entered the password leaves the terminal device without logging out. The similar risk may also be imposed by the method in which the smart card is held by one person because the smart card that is a security device of non-contact type may possibly be left in the card reader loaded, thereby giving a third party a chance of operating the terminal device.

Also, it is difficult for related-art certification technologies to execute access restriction and information provision in accordance with an area in which a device to be used is arranged, on persons subscribing a particular service, separately from the certification for use. When a certification device for personal identification is used, usage permission is executed by use of PIN (Personal Identity Number) code entry or biometrics. However, it is difficult for related-art technologies to prevent the use of the certification device from being used by a third party due to such a handling error by the user as inadvertently leaving the certification device loaded in the reader, for example. If the certification device is lost, it is difficult for related-art technologies to trace back to the source of connection if the lost certification device has been used by a third party.

In order to overcome the above-mentioned problems, a system has been proposed in which communication is executed between a sender terminal and a receiver terminal for personal identification and the usage is permitted only when the receiver terminal is located in the proximity of the sender terminal. However, it is difficult for this system to take the privilege according to the area to be used into consideration and manage a work log if a usage target apparatus is put into a usage restricted status.

The present invention is provided in order to solve the above-described problems. According to an embodiment of the present invention, there is provided a target apparatus providing a predetermined service by certifying a certification device when the certification device enters a predetermined certification area. This target apparatus has a controller configured to control the changing of contents of a service to be provided in accordance with a certification status of a plurality of certification devices located inside the certification area.

According to another embodiment of the present invention, there is provided a certification method that executes certification by a target apparatus for use by a user on a certification device with the certification device located inside a certification area of the target apparatus. This certification method has the step of changing contents of a service to be provided by the target apparatus in accordance with a certification status of a plurality of certification devices located inside the certification area.

Consequently, in providing predetermined services by the target apparatus with the certification device located inside the certification area of the target apparatus, the contents of a service to be provided are changed in accordance with the certification statuses of a plurality of certification devices located inside the certification area. This configuration enhances both the ease of logging in on the target apparatus and the security by the service provision in a predetermined certification status.

For example, if control is executed such that the provision of service is enabled if a plurality of predetermined certification devices are located in the certification area and certified, a sure and easy log-in operation can be realized if the provision of service is started when a plurality of predetermined certification devices are located in the proximity of the target apparatus. Also, if any of the predetermined certification devices exits the certification area, the provision of service is stopped, thereby providing security.

With a predetermined certification device located inside a predetermined certification area and certified and a predetermined service accordingly provided, if a certification device unpredetermined enters the certification area, the provision of a service is stopped, thereby preventing the prying by any third party.

According to still another embodiment of the present invention, there is provided a certification device to be certified by connection to a target apparatus for use by a user to determine whether the target apparatus is available. This certification device has a positional information acquisition block configured to acquire positional information of the target apparatus by a signal supplied from a positional information providing apparatus with the certification device connected to the target apparatus and certification processing block configured to determine whether the user has a usage right based on registered positional information by use of the positional information obtained by the positional information acquisition block and certification information of the user.

According to yet another embodiment of the present invention, there is provided a certification method that certifies a certification device by connecting the certification device to a target apparatus for use by a user to determine whether the target apparatus is available. This certification method has the steps of acquiring, by the certification device, positional information of the target apparatus by a signal supplied from a positional information providing apparatus with the certification device connected to the target apparatus and determining, by the certification device, whether the user has a usage right based on registered positional information by use of the positional information acquired by the certification device and certification information of the user.

In the above-mentioned configuration, when a certification device is connected to the target apparatus for use by a user, user certification information and target apparatus positional information are obtained by the certification device, on the basis of which the presence or absence of usage right is determined. Consequently, the usage right based on position can be set in addition to user certification.

The security level can be enhanced by use of a different certification device than the certification device according to the invention. For example, the certification device according to an embodiment of the invention may be divided into two certification devices (1) and (2). If the certification device (2) enters the certification area set by the certification device (1) with the certification device (1) connected to the usage target apparatus, both the certification devices are cross-certified on the communication path encrypted as occasion demands and positional information is obtained. By referencing the information registered with the certification device (1) beforehand (the positional information and the usage right table that are encrypted and held in a chip inaccessible by the user), certification is made and it is successful if the user having the certification device (2) paired with the certification device (1) is located in the proximity of the usage target apparatus and in an area in which the use and service provision are permitted), upon which the usage target apparatus is unlocked to be available for the user. This certification device (1) may be either incorporated in the usage target apparatus or externally attached thereto.

If accessing the server side such as a service providing apparatus that is a connection target apparatus after the unlocking of the usage target apparatus, the positional information obtained by the certification device (1) is transmitted along with the certification information at the time of successful certification, thereby enabling the management of the information indicative who is accessing from where. This configuration enables the provision of services in accordance with areas or the definition of certification levels such as setting certification restrictions to the connection target apparatus side in accordance with areas.

If the certification device (1) is used as externally attached to the usage target apparatus, an operational log recorded by while the certification device (1) is connected to the usage target apparatus is managed. When the certification device is unloaded or the certification device (2) exits the usage permitted area of the certification device (1), the operation log is deleted from the usage target apparatus, thereby preventing the operation log from being leaked to any third party.

After the successful certification, a session is held between the certification device (1) and certification device (2) and message “Keep Alive” is transferred between these devices at regular intervals. This configuration allows the management of the certification device (2) whether it is located inside the usable area permitted by the certification device (1).

The communication between the certification device (1) and the certification device (2) is executed in the form of encryption and the encryption session key mutually used by these devices is updated at regular intervals.

If the certification device is used without dividing into two, the cross-certification between both the devices occurred can be omitted. Instead, in order to give the usage right of the certification device itself, alternative certification such as PIN (Personal Identity Number) input or biometrics for example may be used. In this case, the certification device may be either incorporated in the usage target apparatus or externally attached thereto.

According to another embodiment of the present invention, there is provided a target apparatus that certifies a certification device when said certification device gets close to said target apparatus. This target apparatus has a communication block configured to detect whether said certification device has entered a predetermined certification area by transmitting and receiving predetermined signals and a controller configured to receive, through said communication block, certification information from said certification device with said certification device located inside said certification area, match said received certification information with registered certification information, and transmit a certification result obtained by the matching to said certification device through said communication block.

According to still another embodiment of the present invention, there is provided a certification device to be certified by a target apparatus for use by a user when the certification devices gets close to the target apparatus. This certification device has a communication block configured to transmit certification information to the target apparatus and receive a certification result from the target apparatus and an unrewritable storage configured to store the certification information.

According to yet another embodiment of the present invention, there is provided a certification method that certifies a certification device by a target apparatus for use by a user when the certification devices gets close to the target apparatus. This method has the steps of determining by the target apparatus whether the certification device has entered a predetermined certification area; receiving, by the target apparatus, certification information from the certification device if the certification device is found located inside the predetermined certification area, matching the received certification information with registered certification information, and transmitting a certification result obtained by the matching to the certification device; and receiving, by the certification device, the certification result from the target apparatus.

In the above-mentioned arrangements, when the certification device enters a predetermined area, the target apparatus certifies the certification device on the basis of the information supplied from the certification device. This configuration realizes automatic certification by getting close by the certification device to the target apparatus.

In addition, the certification levels and post-certification services on the target apparatus can be changed depending on how far the certification device is separated away from the target apparatus inside the a predetermined area.

For example, when the user having the certification device gets close to the target apparatus several meters therefrom, the user is get certified by the target apparatus to log in thereon, thereby getting the provision of any desired services. If the user having the certification device is located inside a predetermined area but apart from the above-mentioned several-meter range, the user can get a part of the services after successful certification by the target apparatus.

As described above, services are provided in accordance with the distance between the user having the certification device and the target apparatus, thereby realizing the provision of services necessary and sufficient for that distance.

In a specific usage example, if the target apparatus is an electronic mail terminal, certification is successful when the user having the certification device gets close to this terminal and the user can access electronic mail on that terminal. This configuration eliminates the necessity for entering user name and password, thereby enhancing user-friendliness. In addition, If the user stands inside a predetermined area of the electronic mail terminal but a little apart therefrom, the user can check, after successful certification, the display screen for the information indicative of electronic mail addressed to the user and the display screen of the certification device for the information indicative whether that terminal is in use by another user.

Therefore, according to the embodiments of the present invention, the status of certification of the certification device with the target apparatus can be automatically verified by use of the certification device, so that, if any user having no access right gets close to the target apparatus, the provision of services is stopped for example, thereby preventing the prying of the display screen to surely prevent information leakage. With a system requiring the certification of a plurality of users, the user certification can be executed with ease and, if any of the users departs from the certification area, the certification is automatically cleared, thereby preventing the system from being used by any third party with the users certified.

Further, according to the embodiments of the present invention, if one target apparatus (or one terminal) is shared by a plurality of users, the information indicative whether the terminal is currently in use by another user or the information indicative whether messages addressed to oneself has arrived can be obtained, thereby realizing the effective use of the shared terminal and the effective use of time by the users without going all the way to the very front of the terminal. Besides, only getting close to the terminal by carrying the certification device allows the logging in on the terminal with ease, thereby enhancing the usability of the system.

### BRIEF DESCRIPTION OF THE DRAWINGS

FIG. 1 is a schematic diagram illustrating an exemplary configuration of a certification system that uses a target apparatus practiced as one embodiment of the invention;

FIG. 2 is a block diagram illustrating exemplary configurations of the target apparatus and a certification device practiced as one embodiment of the invention;

FIG. 3 is a sequence diagram illustrating a sequence for preventing prying eyes when an uncertified wireless UIM gets close to a target apparatus;

FIG. 4 is a sequence diagram illustrating a sequence for preventing prying eyes when a wireless UIM that has no certification function but has only a wireless communication function gets close to a target apparatus;

FIG. 5 is a sequence diagram illustrating a sequence for executing multi-user certification;

FIG. 6 is a sequence diagram illustrating a sequence for logging out multi-user certification;

FIG. 7 is a schematic diagram illustrating an overview of a certification system practiced as one embodiment of the invention;

FIG. 8 is a block diagram illustrating exemplary configurations of a target apparatus and a wireless UIM;

FIG. 9 is a sequence diagram illustrating a sequence for certification to be executed when SSL client certification is used;

FIG. 10 is a schematic diagram illustrating an example in which a mail terminal and a facsimile terminal are used as target apparatuses;

FIG. 11 is a schematic diagram illustrating an exemplary configuration of a certification system to which a certification device practiced as one embodiment of the invention is applied;

FIG. 12 is a functional block diagram illustrating certification devices; and

FIG. 13 is a sequence diagram illustrating a sequence for operational outline.

### DETAILED DESCRIPTION OF THE PREFERRED EMBODIMENTS

This invention will be described in further detail by way of embodiments thereof with reference to the accompanying drawings. In the first embodiment of the invention, a plurality of personal certificating operations are executed by use of a plurality of wireless UIMs that are certification devices, thereby changing services to be provided on the basis of results of these certificating operations.

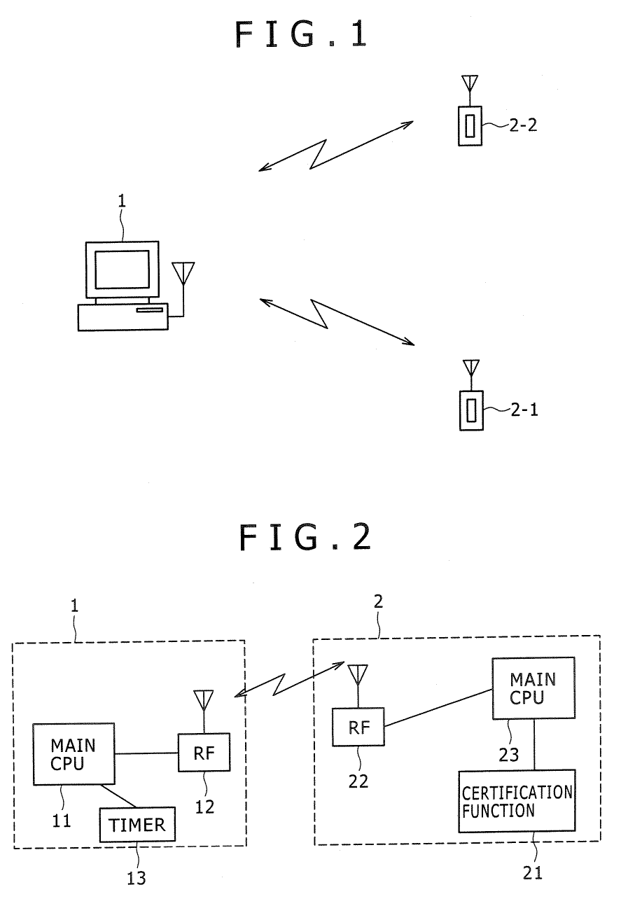

Now, referring to FIG. 1, there is shown an exemplary configuration of a certification system that uses a target apparatus practiced as one embodiment of the invention. To be more specific, a target apparatus 1 executes certification when a wireless UIM that is a certification device 2 gets in a certification area and has a controller for changing service contents depending on the certification status of a plurality of certification devices 2 in a certification area (the example shown in FIG. 1, wireless UIM (1) denoted by 2-1 and wireless UIM (2) denoted by 2-2).

The controller executes control operations, such as control for providing a predetermined service only when two or more predetermined certification devices 2 that have already been certified are located inside a certification area and control for changing the statuses of the provided service upon detection of the entry of a certification service not predetermined into the service area with the predetermined certification device located in the certification area and the predetermined service provided.

In the above-mentioned control example, when the users having a plurality of predetermined certification devices 2 (the wireless UIMs (1) and (2) for example) enter the certification area of the target apparatus 1, log-in is automatically executed, upon which the these users can get predetermined services from the target apparatus 1. It should be noted that predetermined services cannot be provided unless all of the plurality of predetermined certification devices 2 (wireless UIMs (1) and (2) for example) have entered the certification area.

In the latter example, if a user owning a unpredetermined (or unauthorized) certification device 2 (the wireless UIM (2) for example) enters the certification area with a user (an authorized user) owning a predetermined certification device 2 (the wireless UIM (1) for example) located inside the certification area, logged in, and receiving the provision of a predetermined service, for example, actions can be taken against prying eyes by changing service provision conditions, such as alerting the authorized user, executing automatic log-off, or darkening the screen.

Referring to FIG. 2, there is shown exemplary configurations of a target apparatus and a certification device practiced as one embodiment of the invention. The certification device 2 is a wireless UIM for personal identification having a certification block and a wireless communication function, for example. To be more specific, the certification device 2 has a non-rewritable storage block (a Smart card IC for example) 23 for storing certification information, a main CPU 21, and a communication block 22 as a wireless communication function in the certification block. The certification device 2 also has a monitor (not shown) for displaying the information supplied from the target apparatus 1, as occasion demands.

The target apparatus 1 is a device having functions of user certification for mailing, log-in, facsimile transmission, and telephone terminating, for example, and a wireless communication function. To be more specific, the target apparatus 1 has a main CPU 11 for controlling these functions and a communication block 12 having the wireless communication function. The target apparatus 1 also has a timer 13 for counting the time-out timing for certification.

The target apparatus 1 and the certification device 2 can wirelessly communicate with each other through the communication block 12 and the communication block 22. The signal transmission and reception between the target apparatus 1 and the certification device 2 may based on radio wave or optical means such as infrared radiation. The target apparatus 1 can receive a radio signal from the certification device 2 and detects a level thereof, thereby measuring the approximate distance between the target apparatus 1 and the certification device 2.

When the certification device 2 enters a predetermined range around the target apparatus 1, the target apparatus 1 certifies the certification device 2. A method of the certification may be based on digest authentication or SSL (Secure Socket Layer) client authentication, for example.

In the present embodiment, various services are provided depending on the certification status of the certification device 2 located inside the certification area of the target apparatus 1.

The following describes specific certification methods practiced as one embodiment of the invention. It should be noted that the following described will be made by use of a wireless UIM as a certification device by way of example.

<1. Prevention Against Prying Eyes>

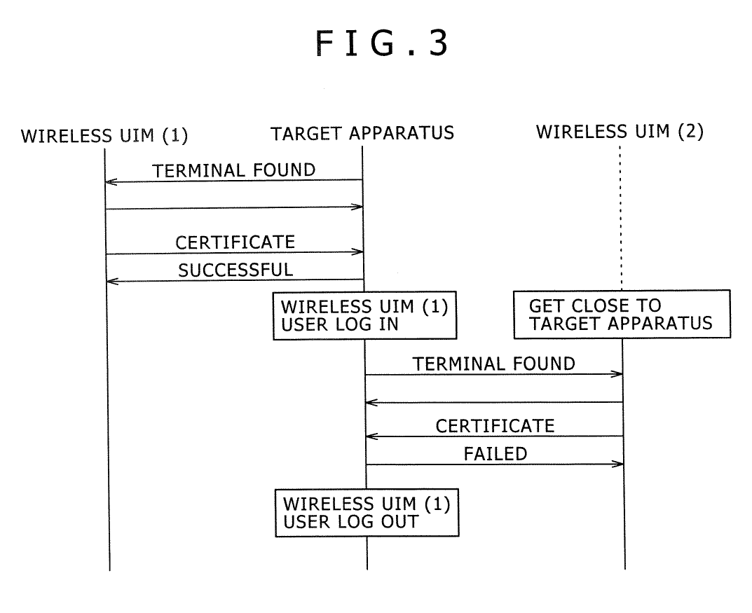

Referring to FIG. 3, there is shown a sequence of taking actions against prying eyes when an uncertified wireless UIM gets close to a target apparatus. First, when a predetermined wireless UIM (1) gets close to a target apparatus, entering the certification area thereof, the wireless UIM (1) is detected by the target apparatus and, if the detected wireless UIM (1) is authenticated by the certification processing, the wireless UIM (1) gets in a certified status. In this certified status, the owner of the wireless UIM (1) can get the provision of services by use of the target apparatus.

Next, when a wireless UIM (2) gets close to the target apparatus, entering the certification area thereof, the wireless UIM (2) is detected by the target apparatus and substantially the same certification processing is executed on the wireless UIM (2). If the wireless UIM (2) has no access right to the target apparatus, the certification processing fails. At this moment, the target apparatus notifies the user of the wireless UIM (1) of the approaching of the wireless UIM (2) by forcibly logging out the wireless UIM (1) or displaying an alert message on the target apparatus or the wireless UIM (2), for example. It is also practicable to darken the display monitor of the target apparatus to make the screen of the display monitor invisible. Consequently, the user of the wireless UIM (1) can prevent beforehand the user of the wireless UIM (2) from prying into the display monitor of the wireless UIM (1).

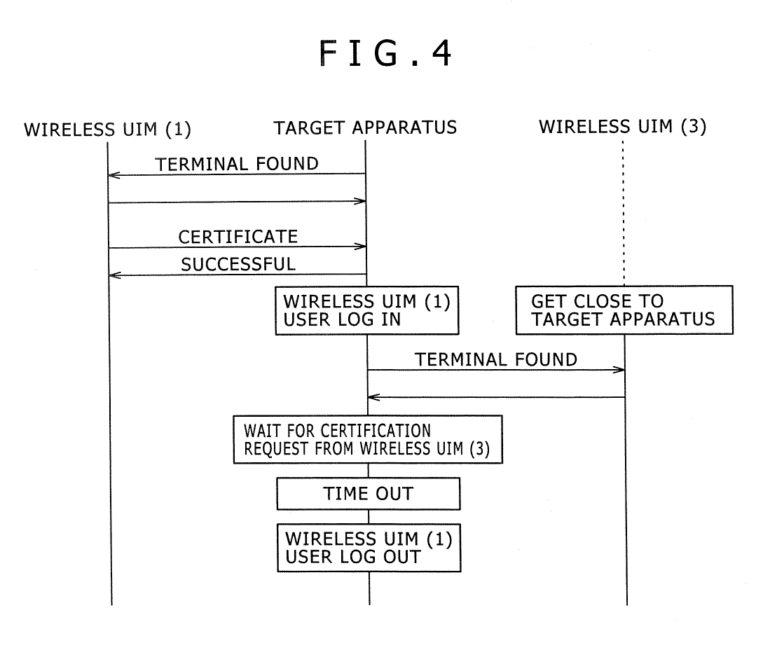

Referring to FIG. 4, there is shown a sequence of preventing prying when a wireless UIM (3) having no certification function but having a wireless communication function gets close to the target apparatus. First, when the wireless UIM (1) predetermined by the target apparatus gets close to the target apparatus, entering the certification range thereof, the wireless UIM (1) is detected by the target apparatus and, if the wireless UIM (1) is authenticated, the wireless UIM (1) gets in a certified status. In the certified status, the owner of the wireless UIM (1) can receive the provision of services by use of the target apparatus.

Next, when the wireless UIM (3) gets close to the target apparatus, entering the certification range thereof, the wireless UIM (3) is detected by the target apparatus and put into a certification request status. The target apparatus has a timer and, if no certification request comes from the wireless UIM (3) within a certain period of time, regards it as the approaching of a wireless UIM having no access right, thereby notifying the user of the wireless UIM (1) of the approaching of the user of the wireless UIM (3) by forcibly logging out the currently used wireless UIM (1) or displaying an alert message on the display monitor of the target apparatus or the wireless UIM (1). It is also practicable to darken the display monitor of the target apparatus to make the screen of the display monitor invisible. Consequently, the user having no access right can be prevented from prying.

<2. Certification of Plural Users>

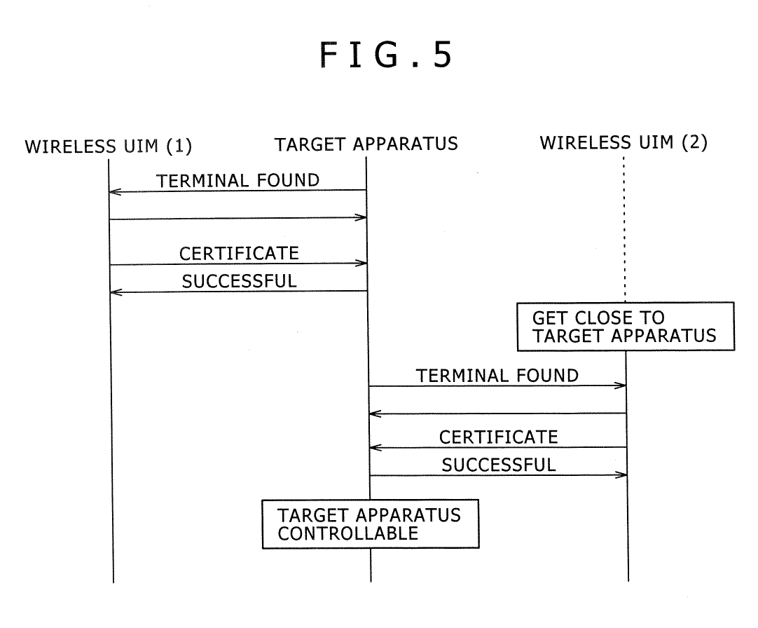

Referring to FIG. 5, there is shown a sequence of certifying a plurality of users. First, when a wireless UIM (1) registered with the target apparatus beforehand gets close to the target apparatus, entering a certification range thereof, the wireless UIM (1) is detected by the target apparatus and certification processing is executed on the wireless UIM (1). If the certification is successful, then the user of the wireless UIM (1) gets in a logged-in status. However, because the target apparatus cannot be used unless a plurality of users having access right have logged in, the target apparatus does not become available by only approaching of the wireless UIM (1).

Next, when a wireless UIM (2) registered with the target apparatus beforehand gets close to the target apparatus, entering a certification range thereof, the wireless UIM (2) is detected by the target apparatus and certification processing is executed on the wireless UIM (2). If the certification is successful, then the user of the wireless UIM (2) also gets in a logged-in status. Consequently, a plurality of users of the registered wireless UIMs (1) and (2) gets in the logged-in status, so that the users are able to get the provision of services in accordance with the certification status of the wireless UIM (1) and (2) by use of the target apparatus. As described above, the log-in status of a plurality of users can be configured only when users of wireless UIM (1) and (2) get close to the target apparatus, thereby realizing, easily for the user, a system of monitoring two or more persons for security reasons.

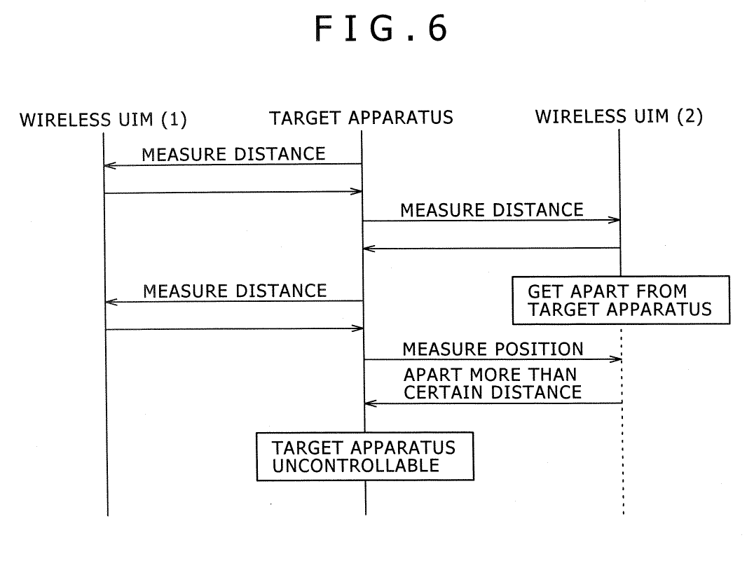

Referring to FIG. 6, there is shown a sequence of executing logging-out of the certification of a plurality of users. The target apparatus measures distances up to wireless UIMs (1) and (2) of users currently logging in at certain intervals. If the target apparatus detects that any of the measured distances exceeds a predetermined value or no response comes from the wireless UIMs (1) and (2) to a distance measurement request within a predetermined period of time, then the target apparatus regards it as that no plural users are logging in on the target apparatus, thereby making itself in unaccessible for use. Consequently, if any of the users of wireless UIMs (1) and (2) gets away from the target apparatus, that user can be automatically logged out, thereby preventing a situation from occurring in which any of the wireless UIMs is left logged-in to impose a risk of the unauthorized use by a third party.

According to the above-mentioned embodiment of the invention, automatic verification of the certification status with the target apparatus 1 by use of the certification device 2 can securely prevent information leakage by preventing prying by users having access right into the display screen for example by alerting or stopping service provision for example if any user having no access right gets close to the target apparatus 1. In addition, with a system requiring the certification of a plurality of users, the user certification can be executed with ease and the certification can be cleared when the users get away from the certification range, thereby preventing the unauthorized use by a third party in the status in which the authorized users are certified.

The following describes a second embodiment of the invention with reference to drawings. In the second embodiment, when a wireless UIM that is a certification device gets close to a target apparatus, the target apparatus automatically certifies the wireless UIM. If the certification is successful, then certification levels and services to be provided by the target apparatus are changed in accordance with the distance from the target apparatus to the wireless UIM.

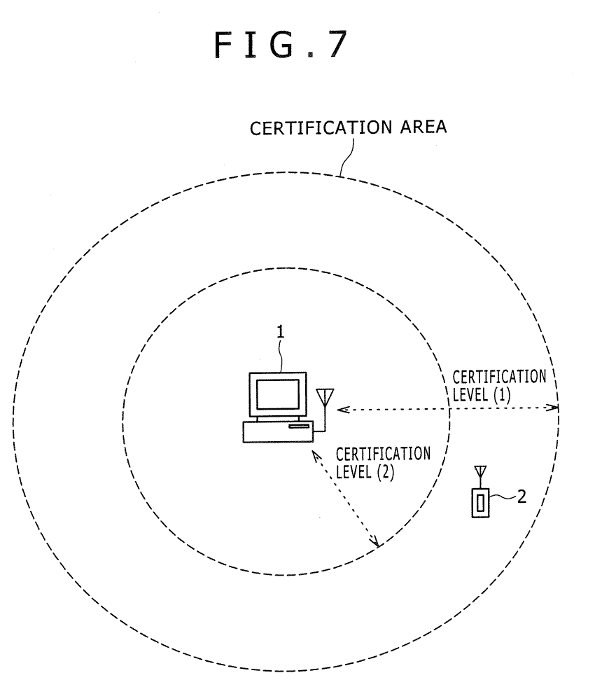

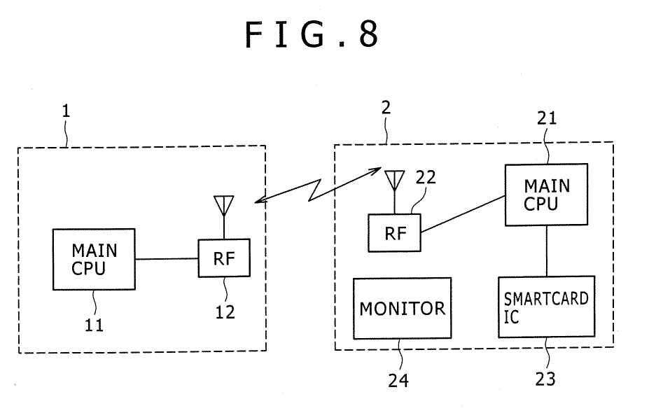

Referring to FIG. 7, there is shown an outline of a certification system practiced as the second embodiment of the invention. To be more specific, a target apparatus 1 for executing certification processing is available for each user of an electronic mail terminal for example. If a wireless UIM 2 that is a certified device is located inside a predetermined area around the target apparatus 1, the target apparatus 1 uses certification information supplied from the wireless UIM 2 to execute certification processing.

Preferably, the wireless UIM 2 is a mobile phone, an employee ID card, or any other wearables. The wireless UIM 2 stores certification information in a non-rewritable storage block thereof. Use of the certification information allows the realization of reliable certification processing on the target apparatus 1.

In the example shown in FIG. 7, two levels of certification areas are arranged in accordance with distances between the target apparatus 1 and the wireless UIM 2; certification level (1) that is farther from the target apparatus 1 and certification level (2) that is nearer thereto, for example. Consequently, provided services can be changed in accordance with distance.

In this example, the distance on which cortication level (2) is based is within several meters (one to two meters for example) from the target apparatus 1 and the distance on which certification level (1) is based is a range (10 to 20 meters for example) in which the target apparatus 1 is visible beyond several meters (one to two meters for example). It should be noted that these certification ranges are set appropriately depending on the types of services to be provided by the target apparatus 1.

Referring to FIG. 8, there is shown exemplary configurations of a target apparatus and a wireless UIM. A wireless UIM 2 is used for personal identification and has a certification function and a wireless communication function. To be more specific, the wireless UIM 2 has an non-rewritable storage block (a smart card IC for example) for storing certification information and a main CPU 21 as the certification function and a communication block 22 as the wireless communication function. The wireless UIM 2 also has a monitor 24 for displaying information supplied from a target apparatus 1 as occasion demands.

The target apparatus 1 is a device having functions of user certification such as mailing, log-in, facsimile transmission, and telephone terminating, for example, and a wireless communication function. To be more specific, the target apparatus 1 has a main CPU 11 for controlling these functions and a communication block 12 having the wireless communication function.

The target apparatus 1 and the wireless UIM 2 can wirelessly communicate with each other through the communication block 12 and the communication block 22. The signal transmission and reception between the target apparatus 1 and the wireless UIM 2 may based on radio wave or optical means such as infrared radiation. The target apparatus 1 can receive a radio signal from the wireless UIM 2 and detects a level thereof, thereby measuring the approximate distance between the target apparatus 1 and the wireless UIM 2.

When the wireless UIM 2 enters a predetermined range around the target apparatus 1, the target apparatus 1 certifies the wireless UIM 2. A method of the certification may be based on digest authentication or SSL (Secure Socket Layer) client authentication, for example.

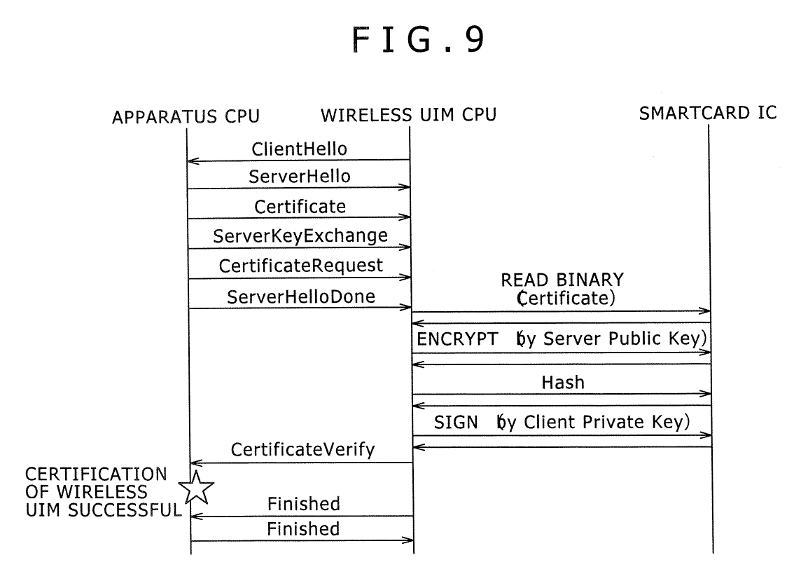

Referring to FIG. 9, there is shown a sequence of certification to be executed when SSL client authentication is used. First, signals are transmitted and received between a target apparatus and a wireless UIM. When the location of the wireless UIM is found in the certification area by the target apparatus, the target apparatus executes the processing for certification. In certification, the wireless UIM obtains a message signature and a certificate by use of the smart card IC that is the storage block incorporated in the wireless UIM.

Next, if the certification of the wireless UIM by the target apparatus is successful, then the status of the wireless UIM is changed to the certified status. At this moment, a certification level is set in accordance with a distance from the target apparatus to the wireless UIM.

When the certification level is divided into two, a result is as shown in FIG. 7. Providing a plurality of certification levels allows the changing of services to be provided by the target apparatus in accordance with the distance from the target apparatus.

For example, if the distance from the target apparatus to the wireless UIM is rather long, notifying the wireless UIM of the current status of the target apparatus allows the user to get information whether to use the target apparatus now or not, for example. If the distance from the target apparatus to the wireless UIM is rather short, then the owner of the wireless UIM can use the target apparatus.

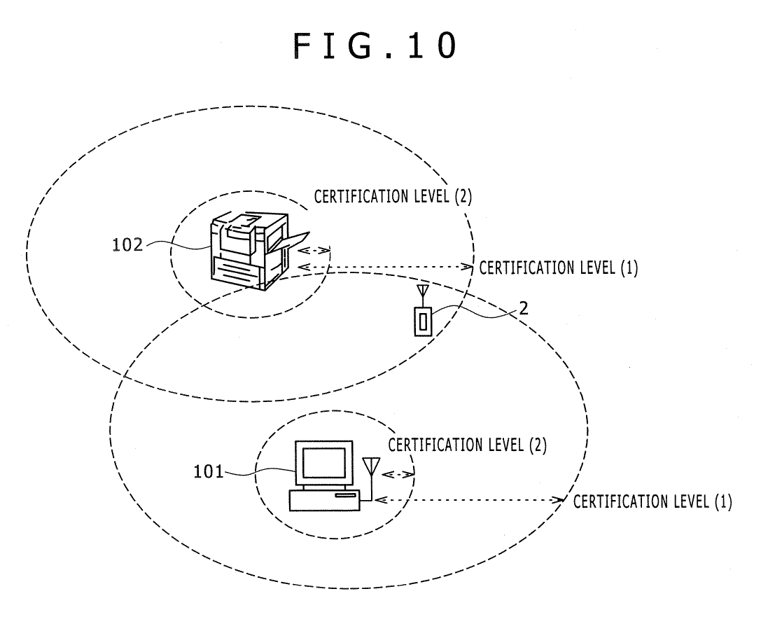

The following describes a method of changing services to be provided, in accordance with the distance of the wireless UIM from the target apparatus. Referring to FIG. 10, there is shown an example in which a mail terminal and a facsimile terminal are used as target apparatuses. In the case of a mail terminal 101, if the distance to the wireless UIM 2 is within a predetermined value, it indicates certification level (1) and the mail terminal 101 notifies the wireless UIM 2 of the information whether mail has arrived at the wireless UIM 2 and the mail terminal 101 is currently used by another person, for example.

When the wireless UIM 2 gets close to the mail terminal 101, it indicates certification level (2), in which the wireless UIM 2 logs in on the mail terminal 101, thereby allowing the user of the wireless UIM 2 to use the mail terminal 101. Namely, if the user of the wireless UIM 2 can get only the information indicative of the arrival of mail addressed to that user even if he cannot read the mail, the wireless UIM 2 can log in on the mail terminal 101 remotely therefrom.

In the case of the facsimile terminal 102, the following operation takes place. Namely, if the distance from the facsimile terminal 102 is rather long, it indicates certification level (1), in which the certification apparatus notified of the arrival of facsimile addressed thereto. When the wireless UIM 2 gets close to the facsimile terminal 102, it indicates certification level (2), in which the facsimile addressed to the user of the wireless UIM 2 is printed upon entering certification level (2). Consequently, because the printing of facsimile is not executed until the user to whom facsimile is addressed gets close to the facsimile terminal 102, a risk of the leakage of facsimile to any unauthorized third party can be avoided.

The above-mentioned certification method based on the above-mentioned target apparatus and certification devices (or wireless UIMs) allows each user to get the information, if a plurality of users share one target apparatus, whether the target apparatus is currently used or mail addressed to him has arrived, on his wireless UIM at hand, remotely from the target apparatus, thereby realizing the effective use of the target apparatus and the effective use of the time of each user. This method also allows each user to easily log in on the target apparatus only by getting close to the target apparatus by carrying the wireless UIM, thereby ensuring security and enhancing usability.

In the above-mentioned second embodiment, two certification levels in accordance with the distances between the target apparatus and certification devices (or wireless UIMs) are used for example. However, the present invention is not limited to this embodiment. It is also practicable to provide more certification levels to accordingly change services to be provided. Further, it is practicable to change the number of certification levels in accordance with services to be provided and change the size of each certification area, thereby executing the more detail provision of services.

The following describes the third embodiment of the invention with reference to drawings.

<System Configuration>

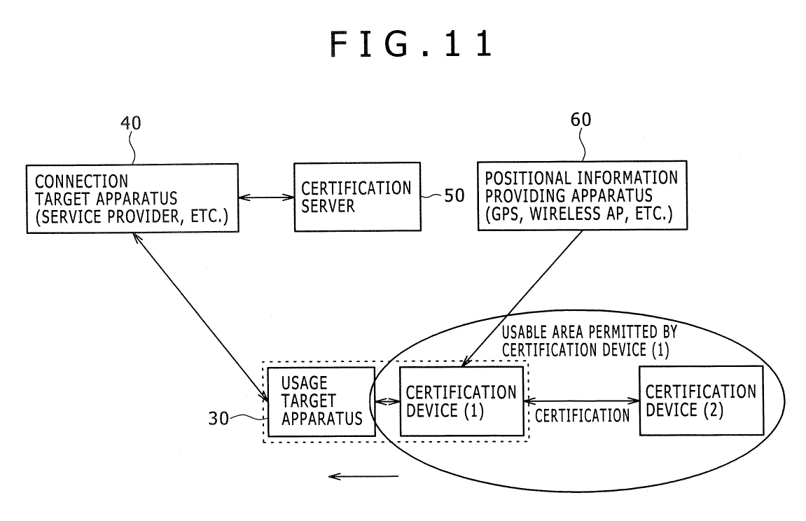

Referring to FIG. 11, there is shown an exemplary configuration of a certification system based on certification devices practiced as one embodiment of the invention. Namely, this certification system has certification devices (1) and (2), a usage target apparatus 30, a connection target apparatus 40, a certification server 50, and a positional information providing apparatus 60 and executes the certification for use of the usage target apparatus 30 on the basis of the positional information obtained from the certification devices (1) and (2) and the positional information providing apparatus 60.

If there is the connection target apparatus 40 that needs line connection necessary for the user to receive the provision of services, the certification device (1) provides certification information and positional information to the connection target apparatus 40 to execute certification processing, upon which the connection target apparatus 40 and the usage target apparatus 30 are interconnected, thereby allowing the user to access in accordance with user right and receive the provision of information.

For the apparatus for providing positional information (namely, the positional information providing apparatus) to the certification device (1), a GPS (Global Positioning System) apparatus or a wireless AP (Access Point) apparatus is used. When the certification device (1) is connected to the usage target apparatus 30, the certification device (1) executes user certification (namely, user certification based on registered certification information) and gets positional information by a signal transmitted from the positional information providing apparatus 60, thereby determining whether the user has use right in the obtained positional information by referencing a usage right table based on the registered positional information.

It should be noted that, because the positional information is obtained by the certification device (1), the positional information is actually the information indicative of the position of the certification device (1); however, because the certification device (1) is connected to the usage target apparatus 30 (directly or via cable or incorporated in the usage target apparatus 30), the positional information is equivalent to the information indicative of the position of the usage target apparatus 30.

If the user has the use right in user certification and positional information, the user is able to receive the provision of services by use of the usage target apparatus 30. Especially, in the third embodiment, the use right can be set by use of positional information, so that information providing services in accordance with persons and use areas can be realized.

Also, in the third embodiment, the certification device (1) has a capability of getting positional information, so that, if the usage target apparatus 30 is general-purpose one, area-restricted services based on user and positional information can be provided.

Further, in addition to the setting of the use right based on user certification and positional information, the third embodiment can execute certification by use of two certification devices (certification device (1) and certification device (2)) for security level enhancement. Namely, the certification device (1) determines whether the certification device (2) is located inside a usable area permitted by the certification device (1) and, if the certification device (2) is found in that area, gives an unlock request to the usage target apparatus.

Consequently, the usage target apparatus becomes available only when the user has the certification device (2) and is located inside the usable area of the certification device (1), so that, if the user leaves the position with the certification device (1) inadvertently left connected to the user target apparatus, the usage target apparatus is kept locked as long as the certification device (2) is located outside the usable area, thereby preventing any third party from illegally using the usage target apparatus.

<Configurations of Certification Devices>

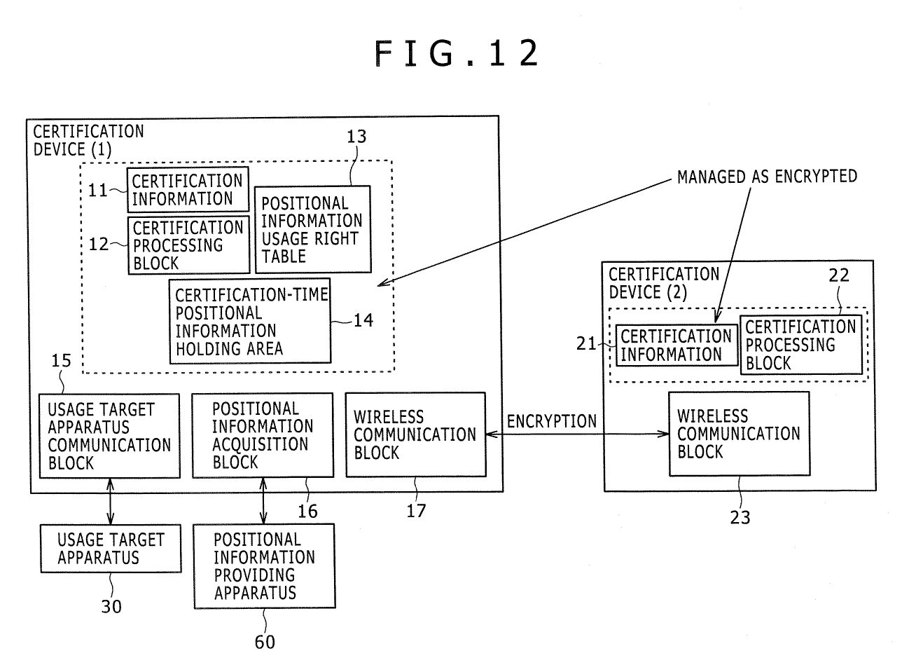

Referring to FIG. 12, there is shown functional blocks of certification devices. A certification device (1) has certification information 11, a certification processing block 12, a positional information usage right table 13, and a certification-time positional information holding area 14 in an area managed in an encrypted manner. In addition, the certification device (1) has a usage target apparatus communication block 15 as a communication block for communication with related equipment, a positional information acquisition block 16, and a wireless communication block 17.

Of the above-mentioned functional blocks, the certification information 11 is information necessary for user certification, which is identification information such as a registered PIN code, for example. The positional information usage right table 13 is indicative of the correlation between area (positional information) and usage right for each certified user and provides data indicative that what kind of usage right is to be given to which area.

The certification processing block 12 certifies the user by use of certification information when the certification device (1) is connected to the usage target apparatus 30 and determines whether the user has the usage right corresponding to the current area by use of the positional information obtained from the positional information providing apparatus 60 by the positional information acquisition block 16 and the positional information usage right table 13.

The certification-time positional information holding area 14 is a memory area in which the positional information obtained when the certification device (1) certifies the user connected to the usage target apparatus 30.

The acquisition of positional information is executed by the positional information acquisition block 16 in a predetermined timed relation. If the positional information obtained at certification stored in the certification-time positional information holding area 14 is the same as the positional information captured in a predetermined timed relation, the usage right is given without change; if there is a difference between these pieces of information, the positional information usage right table 13 is referenced to determine whether there is usage right in that positional information, thereby updating the contents of the certification-time positional information holding area 14 to store the positional information used for the determination.

Therefore, if the usage target apparatus 30 is used inside the area of usage right, the user can continue the usage without change; however, if the usage target apparatus 30 gets out of the area of usage right, the usage right is invalidated and the usage target apparatus 30 may not be used any more.

The certification device (2) has certification information 21 and a certification processing block 22 in an area managed in an encrypted manner. In addition, the certification device (2) has a wireless communication block 23 as a communication block. For the certification information 21, the same information as the certification information 11 stored in the certification device (1). The certification processing block 22 executes certification processing with the certification device (1) by use of this certification information 21. When the certification is successful, the certification device (2) determines whether there is usage right by use of the positional information via the certification device (1).

Between the certification devices (1) and (2), the certification processing is executed by wireless communication block 17 and 23 by transferring encrypted certification information. During this processing, the communication area in the wireless communication block 17 of the certification device (1) provides a usable area permitted by the certification device (1). When these certification devices are located in this usable area, namely the area in which the certification device (2) can wirelessly communicate with the certification device (1), certification is executed. If the certification is successful, the positional information is obtained and determination is made whether there is use right on the basis of the obtained positional information and the user information.

Therefore, when the user has the certification device (2) paired with the certification device (1) and enters the usable area of the certification device (1), the user can use the usage target apparatus 30. If the user exits the usable area of the certification device (1) with the certification device (2), the certification fails and the usage target apparatus 30 is locked. Consequently, if the user departs from the usable area with the certification device (1) inadvertently left connected to the usage target apparatus 30, the usage target apparatus 30 is locked as long as the certification device (2) is located outside the usable area, thereby preventing the unauthorized use by any third party.

If the certification devices (1) and (2) are not used separately as shown above (if the certification device (2) is directly connected to the certification device (1) for example), the certification information 11 and certification information 21 and the certification processing block 12 and the certification processing block 22 are shared by these certification devices. Therefore, with no certification processing portion arranged for executing certification between the certification devices, executing a given certification (PIN entry or biometrics for example) can replace other processing sequences.

<Operations and Certification Method>

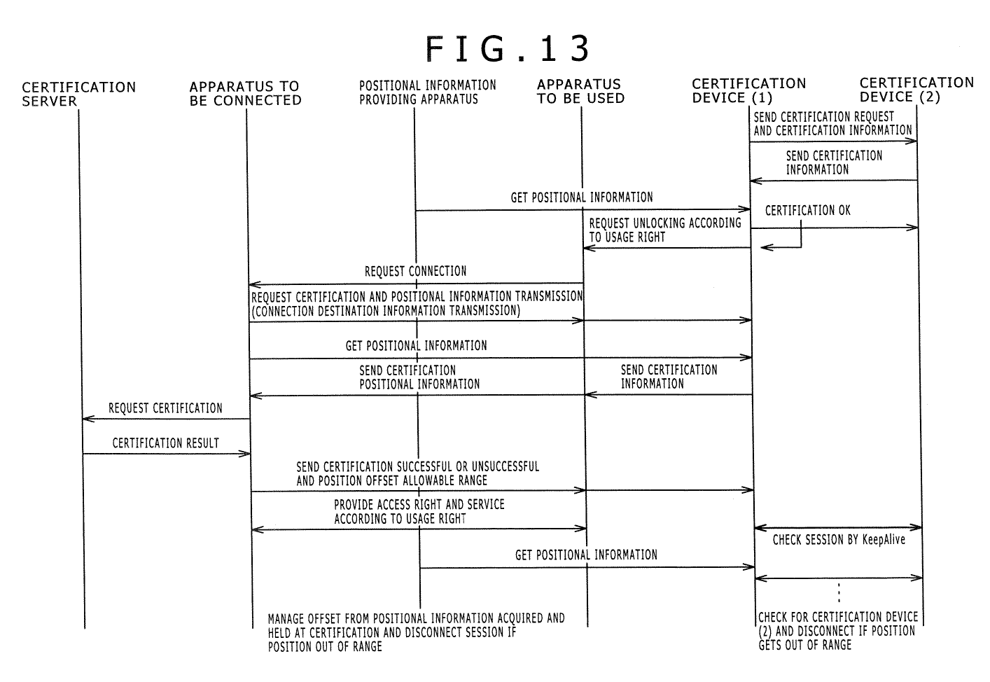

Referring to FIG. 13, there is shown a sequence for describing an operational outline. For reference numerals used in the following description but not shown in FIG. 13, refer to FIGS. 11 and 12. In operational outline, if the certification device (2) is located inside the usable area provided by the certification device (1), then the certification device (1) transmits the certification information 11 thereof to the certification device (2) via the wireless communication block 17 and demands for a certification request. The certification device (2) checks the received certification information 11 and, if no problem is found in the certification information 11, transmits the certification information 21 of the certification device (2) to the certification device (1).

Next, receiving the certification information 21 from the certification device (2), the certification device (1) verifies the received certification information 21, obtains positional information from the positional information providing apparatus 60, and compares the certification information 21 of the certification device (2) with the positional information usage right table 13 held in the certification device (1), thereby determining whether there is usage right. If usage right is found, the certification is determined to be successful, upon which the certification device (1) transmits the certification result to the certification device (2) and transmits an unlock request according to usage right to the usage target apparatus 30. Consequently, the usage target apparatus 30 becomes available.

Subsequently, the session between the certification devices (1) and (2) is held and the certification device (1) gets in a status in which to always monitor the existence of the certification device (2) by means of “Keep Alive” message, for example.

If no response comes from the certification device (2) (the usable area is exited) or the positional information is always obtained and the usage target apparatus 30 is carried out of the usage range (the area of usage right), the certification device (1) transmits a lock request to the usage target apparatus 30. Consequently, the usage target apparatus 30 is put in a locked status, becoming not usable.

Next, an attempt is made to connect to the connection target apparatus 40 by use of the usage target apparatus 30. Alternatively, if the provision of information is requested, a connection request is transmitted from the usage target apparatus 30 to the connection target apparatus 40. Receiving the connection request, the connection target apparatus 40 transmits certification and positional information transmission requests to the usage target apparatus 30 along with the certification information of the connection target apparatus 40.

Receiving the above-mentioned requests from the connection target apparatus 40, the usage target apparatus 30 provides the above-mentioned information to the certification device (1). The certification device (1) provides the certification information 11 along with the obtained positional information. Next, the usage target apparatus 30 transmits this information to the connection target apparatus 40. The connection target apparatus 40 transmits a certification request to the upper certification server 50 and receives a result of the certification. If the certification is successful, the connection target apparatus 40 transmits usable area information to the usage target apparatus 30. Consequently, the access right according to usage right or the provision of services (the reception of information) becomes available on the usage target apparatus 30.

The received message is managed on the certification device (1). Subsequently, the positional information and the information indicative of presence or absence of the certification device (2) are continuously managed on the certification device (1). If one of these items of information is found certified to be unsuccessful, the usage target apparatus 30 immediately gets in the locked status, thereby making the usage target apparatus 30 unavailable.

The certification between the certification devices (1) and (2) and the certification between the connection target apparatus 40 and the usage target apparatus 30 are executed on the basis of a general-purpose certification sequence, such as SSL (Secure Socket Layer), for example. Operational log information indicative of operations executed from the unlocking of the usage target apparatus to the relocking thereof is managed on the certification device (1). If the certification fails due to the exiting from the usable area of the certification device (2) or certification device (1) or the exiting of the usage target apparatus 30 from the area of usage right or, upon completion of the use, this log information is deleted from the usage target apparatus 30. This configuration prevents the operational log information from being used by any unauthorized third party after the use of the usage target apparatus 30 by the authorized user.

As described above, the above-mentioned sequence allows the user wanting to use particular services to connect the certification device to the usage target apparatus 30 located inside a particular area, thereby providing access restriction and information offering on the basis of the user certification and the information about a position at which the usage target apparatus 30 is located, in accordance with the user and the area. In addition, the above-mentioned sequence can prevent the usage target apparatus 30 from being used by any unauthorized party due to inadvertent leaving of the certification device loaded on the usage target apparatus 30. Further, if usage restriction is set on the usage target apparatus 30, the operational log information is deleted from the usage target apparatus 30, thereby preventing the operational log information from being used by any unauthorized third party.

<Application to Television Phones>

In making a television phone call or a telephone call, it may be uncertain that the desired called party is present at the opposite end or a third pay may answer the call. So, in order to make it sure that the desired party answer the call, certification is executed in accordance with the distance from the terminal (in this case, the telephone set of the opposite end). For example, if the called party is located a certain distance from the terminal, the certification is not executed and the presence information indicative that the desired called party is not located nearby is transmitted to the calling party. On the other hand, if the called party is located inside a predetermined range of the terminal and therefore wireless UIM certification is successful, then the presence information indicative that the desired called party is at the opposite end is transmitted to the calling party.

For the above-mentioned certain distance from the terminal, a range is assumed in which a ringing tone can be heard in a house. When a television phone call terminates, the called party can answer when he gets close to the television phone terminal. This configuration can prevent a television phone call from being answered by any third party.

In communicating on television phone, it is possible for the screen of the television phone set to be seen by a third party. In order to overcome this problem, entry of the third party user of a wireless UIM (the wireless UIM (2) for example) into the certification area of the television phone while the user of the wireless UIM (1) is making a call by the television phone (corresponding to the target apparatus of the embodiments of the present invention) is detected. If the entering wireless UIM is not predetermined one, the prying by any third party is prevented by making the screen of the television phone invisible or giving an alert message to the user of wireless UIM (1), for example.

For the above-mentioned certification area, a range is assumed in which the screen of the television phone is recognizable. This configuration can prevent the screen of the television phone from being seen by any third party.

While preferred embodiments of the present invention have been described using specific terms, such description is for illustrative purpose, and it is to be understood that changes and variations may be made without departing from the spirit or scope of the following claims.

What is claimed is:

1. A target apparatus that provides a predetermined service by certifying a certification device when said certification device enters a predetermined certification area, comprising:
control means configured to control the changing of contents of a service to be provided in accordance with a certification status of a plurality of certification devices located inside said certification area.

2. The target apparatus according to claim 1,
wherein said control means controls the provision of a predetermined service when said plurality of certification devices located in said certification area are certified.

3. The target apparatus according to claim 1,
wherein said control means controls the changing of statuses of the provision of a predetermined service when a certification device unpredetermined enters said certification area with said predetermined certification device located inside said certification area successfully certified and providing said predetermined service.

4. A certification method that executes certification by a target apparatus for use by a user on a certification device with said certification device located inside a certification area of said target apparatus, comprising the step of:
changing contents of a service to be provided by said target apparatus in accordance with a certification status of a plurality of certification devices located inside said certification area.

5. The certification method according to claim 4,
wherein said target apparatus provides a predetermined service when said plurality of certification devices located in said certification area are certified.

6. The certification method according to claim 4,
wherein said target apparatus changes statuses of the provision of a predetermined service when a certification device unpredetermined enters said certification area with said predetermined certification device located inside said certification area certified and providing said predetermined service.

7. A target apparatus that certifies a certification device when said certification device gets close to said target apparatus, comprising:
communication means configured to detect whether said certification device has entered a predetermined certification area by transmitting and receiving predetermined signals; and
control means configured to receive, through said communication means, certification information from said certification device with said certification device located inside said certification area, match said received certification information with registered certification information, and transmit a certification result obtained by the matching to said certification device through said communication means.

8. The target apparatus according to claim 7,
wherein said control means changes, through said communication means, certification levels in accordance with how distant said certification device is from said target apparatus inside said certification area.

9. A certification device to be certified by a target apparatus for use by a user when said certification devices gets close to said target apparatus, comprising:
communication means configured to transmit certification information to said target apparatus and receive a certification result from said target apparatus; and
unrewritable storage means configured to store said certification information.

10. The certification device according to claim 9 further comprising:
display means configured to display said certification result received through said communication means.

11. A certification method that certifies a certification device by a target apparatus for use by a user when said certification devices gets close to said target apparatus, comprising the steps of:
determining by said target apparatus whether said certification device has entered a predetermined certification area;
receiving, by said target apparatus, certification information from said certification device if said certification device is found located inside said predetermined certification area, matching said received certification information with registered certification information, and transmitting a certification result obtained by the matching to said certification device; and
receiving, by said certification device, said certification result from said target apparatus.

12. The certification method according to claim 11,
wherein said target apparatus changes certification levels in accordance with how distant said certification device is from said target apparatus inside said certification area.

13. The certification method according to claim 11,
wherein said target apparatus changes available services in accordance with how distant the certification device is from said target apparatus inside said certification area.

14. The certification method according to claim 11,
wherein said certification device displays said certification result received from said target apparatus.

15. The certification method according to claim 14,
wherein said certification device executes the display in accordance with a certification level set by said target apparatus.

16. The certification method according to claim 14,
wherein said certification device executes the display in accordance with available services set by said target apparatus.

17. A certification device to be certified by connection to a target apparatus for use by a user to determine whether said target apparatus is available, comprising:
a positional information acquisition block configured to acquire positional information of said target apparatus by a signal supplied from a positional information providing apparatus with said certification device connected to said target apparatus; and
a certification processing block configured to determine whether said user has a usage right based on registered positional information by use of said positional information obtained by said positional information acquisition block and certification information of said user.

18. The certification device according to claim 17,
wherein said certification processing block acquires said positional information at regular intervals and, every time the acquisition is executed, determines whether there is said usage right by use of said positional information and said user certification information.

19. The certification device according to claim 17 further comprising:
a communication block configured to communicate information indicative whether there is another certification device inside a predetermined area,
wherein, if another certification device is detected by said communication block, said certification processing block certifies said detected certification device and determines whether there is a usage right based on certification information of said user and said positional information if the certification is successful.

20. A certification method that certifies a certification device by connecting said certification device to a target apparatus for use by a user to determine whether said target apparatus is available, comprising the steps of:
acquiring, by said certification device, positional information of said target apparatus by a signal supplied from a positional information providing apparatus with said certification device connected to said target apparatus; and
determining, by said certification device, whether said user has a usage right based on registered positional information by use of said positional information acquired by said certification device and certification information of said user.

21. The certificating method according to claim 20,
wherein, if another certification device is detected inside a predetermined area set by said certification device and if said detected certification device is certified, determination is made by said certification device whether there is said usage right on the basis of said positional information and certification information of said user.

22. The certification method according to claim 20 further comprising the steps of:
transmitting, if the usage right of said user is found, the certification information of said user and said positional information from said target apparatus to an external service providing apparatus; and
determining whether the provision of services by said service providing apparatus is enabled on the basis of the certification information of said user and said positional information.

23. The certification method according to claim 20 further comprising the step of:
deleting, if said usage right is found by said certification device and said usage right is invalidated after use of said target apparatus by said user, a usage log recorded by said user from said target apparatus.

24. A target apparatus that provides a predetermined service by certifying a certification device when said certification device enters a predetermined certification area, comprising:
a controller configured to control the changing of contents of a service to be provided in accordance with a certification status of a plurality of certification devices located inside said certification area.

25. A target apparatus that certifies a certification device when said certification device gets close to said target apparatus, comprising:
a communication block configured to detect whether said certification device has entered a predetermined certification area by transmitting and receiving predetermined signals; and
a controller configured to receive, through said communication block, certification information from said certification device with said certification device located inside said certification area, match said received certification information with registered certification information, and transmit a certification result obtained by the matching to said certification device through said communication block.

26. A certification device to be certified by a target apparatus for use by a user when said certification devices gets close to said target apparatus, comprising:
a communication block configured to transmit certification information to said target apparatus and receive a certification result from said target apparatus; and
an unrewritable storage configured to store said certification information.
